(19) United States
(12) Patent Application Publication
(10) Pub. No.: US 2007/0248900 A1
(43) Pub. Date: Oct. 25, 2007

(54) Developer, image forming apparatus and image forming method

(76) Inventors: Naruo Yabe, Osaka-shi (JP); Kouzou Teramoto, Osaka-shi (JP); Tomohiko Kubo, Kobe-shi (JP); Akinori Koyama, Osaka-shi (JP)

Correspondence Address: CLARK & BRODY, 1090 VERMONT AVENUE, NW, SUITE 250, WASHINGTON, DC, 20005, US

(21) Appl. No.: 11/730,053

(22) Filed: Mar. 29, 2007

(30) Foreign Application Priority Data
Mar. 30, 2006 (JP) 2006-094329

(51) Int. Cl. G03G 15/01; G03G 9/09

(52) U.S. Cl. 430/45.51; 430/107.1; 430/110.3; 430/47.2; 430/108.6

(57) ABSTRACT

A developer used for an image forming apparatus including the step of forming a color image by using a single photoreceptor and removing a toner remaining on the photoreceptor after the transfer step with a cleaning blade, which developer is composed of a black toner having a circularity of 0.96 or less and a color toner having a circularity of 0.96 or more, in which at least inorganic particles containing Si compound particles and Ti compound particles are externally added to both of the black toner and the color toner, and the amount of the inorganic particles externally added to the black toner and the color toner satisfies the expressions (1) and (2).
{Si(C)+Ti(C)}≧1.5×{Si(Bk)+Ti(Bk)} (1)
Ti(C)≧1.5×Ti(Bk) (2) (In the expressions, Si(C), Ti(C), Si(Bk) and Ti(Bk) are as described in the specifications.)

Priority is claimed to Japanese Patent Application No. 2006-094329 filed on Mar. 30, 2006, the disclosure of which is incorporated by reference in its entirety.

### BACKGROUND OF THE INVENTION

1. Field of the Invention

The present invention relates to a color image forming apparatus and a developer used therein, and particularly to a developer excellent in cleaning performance and an image forming apparatus.

2. Description of Related Art

Conventionally, in electrophotography, a pigmented toner is developed on an electrostatic latent image formed by charging and exposing an image carrier (hereinafter referred to also as a photoreceptor) surface to form a toner image, which is thereafter transferred to transfer paper and fixed by a heated roll to form an image. An untransferred toner and a toner component remain on photoreceptor surface through the transfer step, so that these residual toners need to be removed by cleaning treatment.

In recent years, an image forming system utilizing a toner with high sphericity has vigorously been commercialized for achieving higher image quality of a color image. However, a toner with high sphericity easily causes passing through a cleaning blade of a photoreceptor, namely, cleaning defect. Thus, in order to prevent the above-mentioned passing through a cleaning blade, it is known that an amorphous magnetic toner with low sphericity is used together with a non-magnetic toner with high sphericity. However, the above-mentioned amorphous magnetic toner and non-magnetic toner with high sphericity differ greatly in grindability of a photoreceptor, so that image defect is caused due to filming (formation of an oxide film and adhesion of paper powder and toner component) onto a photoreceptor surface when an image using only a spherical non-magnetic toner having low grinding force is repeatedly outputted, for example.

For example, in Japanese Unexamined Patent Publication No. 2002-169339, it is proposed that the passing through a cleaning blade is prevented by determining the sphericity (hereinafter referred to also as circularity) of a color toner at 0.96 or more and the sphericity of a black toner at less than 0.96. However, in this method, in a case where an image of only a color toner with high sphericity is outputted over a long period, malfunctions are feared such as to cause cleaning defect and filming onto a photoreceptor surface.

In Japanese Unexamined Patent Publication No. 2002-214870, a proposal that image quality is maintained by providing a grinding means in a rotary development apparatus is made for the purpose of rubbing and removing adhesive materials to a photoreceptor surface. However, in this method, the problem is that upsizing of the apparatus is brought and no space is secured in a small-sized apparatus.

### SUMMARY OF THE INVENTION

The advantage of the present invention is to provide a developer in which a photoreceptor surface can be maintained in a favorable state even in long-period use to stably allow a color image of high image quality without upsizing an apparatus.

A developer of the present invention is a developer used for an image forming apparatus including the step of forming a color image by using a single photoreceptor and removing a toner remaining on the photoreceptor after the transfer step with a cleaning blade, which developer is composed of a black toner having a circularity of 0.96 or less and a color toner having a circularity of 0.96 or more, in which at least inorganic fine particles containing Si and inorganic fine particles containing Ti are externally added to both of the black toner and the color toner, and the amount of the inorganic fine particles externally added to the black toner and the color toner satisfies the following expressions (1) and (2).
{Si(C)+Ti(C)}≧1.5×{Si(Bk)+Ti(Bk)} (1)
Ti(C)≧1.5×Ti(Bk) (2)
In the expressions, Si(C): the amount of inorganic fine particles containing Si externally added to a color toner (% by mass), Ti(C): the amount of inorganic fine particles containing Ti externally added to a color toner (% by mass), Si(Bk): the amount of inorganic fine particles containing Si externally added to a black toner (% by mass), Ti(Bk): the amount of inorganic fine particles containing Ti externally added to a black toner (% by mass), and % by mass is a value with respect to the toner total amount.

With regard to a developer of the present invention, it is preferable that a black toner is a magnetic toner produced by a grinding method and a color toner is a non-magnetic toner produced by a polymerization method. In addition, the amount of the inorganic fine particles externally added to a black toner preferably satisfies the following expression (3).
Si(Bk)+Ti(Bk)≧1.5 (3)
In the expression, Si(Bk) and Ti(Bk) are as defined above.

According to the present invention, the use of a spherical toner having a circularity of 0.96 or more for a color toner allows a color image of high image quality, and the prescription of the circularity of a black toner allows an image with no cleaning defect.

The prescription of the external additive amount of a black toner and a color toner allows a favorable grinding state of a photoreceptor to be retained regardless of the output ratio of black and color, and thus allows a favorable image with no defect due to filming and photoreceptor shaving even in long-period use.

A color toner typically signifies toners such as magenta, cyan and yellow except a black toner. A toner includes toner particles and an external additive externally added thereto.

An image forming apparatus of the present invention uses a developer described above and includes the step of forming a color image by using a single photoreceptor and removing a toner remaining on the photoreceptor after the transfer step with a cleaning blade.

Therefore, it is possible to provide an image forming apparatus in which a photoreceptor surface can be maintained in a favorable state even in long-period use to stably allow a color image of high image quality without upsizing an apparatus

### BRIEF DESCRIPTION OF THE DRAWINGS

FIG. 1 is a schematic diagram of a color image forming apparatus according to an embodiment of the present invention.

### DESCRIPTION OF PREFERRED EMBODIMENTS

A developer of the present invention is a developer preferably used for an image forming apparatus including the step of forming a color image by using a single photoreceptor and removing a toner remaining on the photoreceptor after the transfer step with a cleaning blade, which developer is composed of a black toner having a circularity of 0.96 or less and a color toner having a circularity of 0.96 or more. At least inorganic fine particles containing Si and inorganic fine particles containing Ti are externally added to both of the above-mentioned black toner and color toner, and the amount of the inorganic fine particles externally added to the black toner and the amount of the inorganic fine particles externally added to the color toner with respect to the toner total amount satisfy the above-mentioned expressions (1) and (2).

The determination of the circularity of a black toner at 0.96 or less allows ordinary cleaning performance to be secured. The determination of the average circularity of a color toner at 0.96 or more allows favorable flowability, favorable transfer efficiency and an image of high image quality. However, in consideration of various kinds of noises in the print output environment, such as temperature, humidity and influence of paper powder from transfer paper, it is not conceived that there is sufficient margin in cleaning properties. Then, the above-mentioned expression (1) is satisfied as a method of securing this margin, so that the amount of the inorganic fine particles added to a color toner is increased and cleaning performance of a spherical toner can be improved.

Here, average circularity is defined as a value obtained in such a manner that the measurement is performed by using a flow-type particle image analysis device to calculate circularity of measured particles by the following expression and additionally divide the total sum of circularity of all the measured particles by the number of all the particles.
Circularity a=Lo/L (4)
In the expression, Lo is circumference of a circle having the same projected area as a particle image and L is circumference of the particle image.

On the other hand, the grinding of filming formed on a photoreceptor surface is performed by a toner. The grindability of a toner is determined by irregularities of a toner particle surface, hardness and shape of internally added substances, and shape, size and content of externally added particles. With regard to a toner surface shape, the presence of irregularities on the surface brings higher grindability than a smooth surface such as a spherical toner having high circularity. The inclusion of a hard substance such as magnetic powder in internally added substances brings far higher grindability. Also with regard to externally added inorganic fine particles, higher hardness brings higher grindability.

In the present invention, it is noted that titanium oxide among inorganic fine particles is higher in grindability than silica, and the added amount of inorganic fine particles satisfies the above-mentioned expressions (1) and (2). The amount of titanium oxide higher in grindability is prescribed by the above-mentioned expressions (1) and (2), so that grindability as the total toner of a color toner and a black toner, namely, difference in grinding between external addition by a color toner and internal addition by a black toner can be decreased and well-balanced grindability of a photoreceptor is obtained.

In a case where the above-mentioned color toner and black toner differ greatly in grinding, a grinding state of a drum varies between a case of using many color images and a case of using many black toners in long-period use. As a result, removal defect of filming due to shortage of grinding or photoreceptor shaving due to excessive grinding of a photoreceptor is caused, either of which brings image malfunctions.

The total amount of silica and titanium oxide externally added to a black toner preferably satisfies the above-mentioned expression (3), more preferably 1.5 to 2.0% by mass. Thus, the same effect as the above is obtained against the above-mentioned image malfunctions.

(Inorganic Fine Particles)

The above-mentioned silica and titanium oxide are preferably used as inorganic fine particles used in the present invention, examples of which include alumina, zinc oxide and magnesium oxide, and one kind or two kinds or more thereof can be used together. Examples of silica powder include AEROSIL RA200H, NAY200, NA50H, R972, R974, 90, SILICA D-17, T-805, R-812, RA200 and HRX-C manufactured by NIPPON AEROSIL; TG820F, TG824F, Cab-o-SilM-5, MS-7, MS-75, HS-5, EH-5, S-17 and TS-72 manufactured by CABOT JAPAN K. K.; and KE-E30 and KE-E40 manufactured by NIPPON SHOKUBAI CO., LTD. Examples of titanium oxide powder include MT-150A and MT-500B manufactured by Tayca Corporation; and STT-100AF-50 manufactured by Titankogyo.

The added amount of the above-mentioned inorganic fine particles is preferably in a range of 1.0 to 5.0% by mass with respect to the toner total amount. The mixing of the external additive and toner particles can be performed by using a Henschel mixer, a V type mixer, a tumbling mixer and a hybridizer and so forth.

The surface of the above-mentioned inorganic fine particles may be surface-treated with silane coupling agent, aminosilane, silicone oil or titanate coupling agent for the purpose of hydrophobization and conductive treatment as required.

The used amount of these surface treatment agents is preferably 0.05 to 20 parts by weight with respect to 100 parts by weight of the above-mentioned inorganic fine particles.

Examples of silane coupling agent include organoalkoxysilane (such as methoxytrimethylsilane, dimethoxydimethylsilane, trimethoxymethylsilane and ethoxytrimethylsilane); organochlorosilane (such as trichloromethylsilane, dichlorodimethylsilane, chlorotrimethylsilane, trichloroethylsilane, dichlorodiethylsilane, chlorotriethylsilane and trichlorophenylsilane); organosilazane (such as triethylsilazane, tripropylsilazane and triphenylsilazane); organodisilazane (such as hexamethyldisilazane, hexaethyldisilazane and hexaphenyldisilazane); and other organosilane. These may be used singly or together in two kinds or more. Among the above-mentioned silane coupling agents, organochlorosilane, organosilazane and organodisilazane are preferably used. Examples of aminosilane include N-2(aminoethyl)3-aminopropylmethyldimethoxysilane, N-2(aminoethyl)3-aminopropyltrimethoxysilane, N-2(aminoethyl)3-aminopropyltriethoxysilane, 3-aminopropyltrimethoxysilane, 3-aminopropyltriethoxysilane and N-phenyl-3-aminopropyltrimethoxysilane. Among the above-mentioned aminosilane, 3-aminopropyltrimethoxysilane is preferably used.

Examples of silicone oil include dimethyl silicone oil, methylphenyl silicone oil, methyl hydrogen silicone oil, fluorosilicone oil and denatured silicone oil. These may be used singly or together in two kinds or more. The above-mentioned silicone oil may be cured by crosslinking agent and heat treatment as required. Among the above-mentioned silicone oil, dimethyl silicone oil is preferably used.

Examples of titanate coupling agent include isopropyl triisostearoyl titanate, isopropyl triculmyl phenyl titanate and tetraisopropylbis(dioctyl phosphite) titanate. These may be used singly or together in two or more kinds. Among the above-mentioned titanate coupling agent, isopropyl triisostearoyl titanate is preferably used.

(Toner)

With regard to a toner of the present invention, it is preferable that a black toner is a magnetic single-component toner produced by a grinding method and a color toner is a non-magnetic single-component toner produced by a polymerization method. However, the toners are not limited thereto but may be produced by any producing method.

Toner mother particles of the present invention can be obtained as toner mother particles by dispersing various toner compounding agents such as a coloring agent in binding resin by a grinding method.

That is, toner mother particles are obtained in such a manner that the above-mentioned binding resin and various toner compounding agents are mixed and melt-kneaded by using a kneader such as an extruder, and thereafter cooled, ground and classified. The above-mentioned toner mother particles are preferably adjusted in granularity, such as a central particle diameter on a volume basis of approximately 4 to 12 μm, preferably 6 to 10 μm.

With regard to the adjustment of a toner particle shape, for example, as described above, when each of the above-mentioned components is mixed by a grinding method and melt-kneaded, and thereafter ground and further classified as required, the following for applying higher stress than usual are used as a grinder used for fine grinding after coarse grinding: mechanical grinders such as trade name “TURBOMILL”, manufactured by Turbo Kogyo Co., Ltd.; trade name “FINEMILL”, manufactured by Nippon Pneumatic Mfg. Co., Ltd.; trade name “INOMIZER”, manufactured by Hosokawa Micron Corporation; trade name “SUPER ROTOR”, manufactured by Nisshin Engineering Inc.; and trade name “ZEPROS” and “KRYPTRON”, manufactured by Kawasaki Heavy Industries, Ltd. than a jet mill. The adjustment can be performed by adjusting the grinding conditions so as to prolong grinding time and repeating the grinding step plural times. Sphericity treatment can be performed by the treatment for a certain time with a high-speed stirring type mixer such as a Henschel mixer manufactured by MITSUI MINING COMPANY, LIMITED after the grinding step and by the heat treatment step such as a suffusing system (Nippon Pneumatic Mfg. Co., Ltd.), as other methods.

A polymerization method can also be used for obtaining toner mother particles having a circularity of 0.96 or more. A suspension polymerization method and an emulsion polymerization method are principally used in a polymerization method. In a polymerization method, a monomeric substance (a monomer), wax, a coloring agent, and additionally a charge control agent, a polymerization initiator and a crosslinking agent as required are used; a mixture or fluid dispersion in which other additives are added to a monomeric substance is granulated and polymerized while stirred in an aqueous phase to obtain toner mother particles having desirable particle size. The above-mentioned toner mother particles are preferably adjusted in granularity, such as a central particle diameter on a volume basis of approximately 4 to 12 μm, preferably 6 to 10 μm.

(Binding Resin)

Kinds of binding resin used for a toner in the present invention are not particularly limited and yet thermoplastic resins are preferably used, such as styrene based resin, acrylic based resin, styrene-acrylic based copolymer, polyethylene based resin, polypropylene based resin, vinyl chloride based resin, polyester based resin, polyamide based resin, polyurethane based resin, polyvinylalcohol based resin, vinyl ether based resin, N-vinyl based resin and styrene-butadiene resin.

More specifically, polystyrene based resin may be a homopolymer of styrene or a copolymer with other copolymerizable monomers with styrene. Examples of the copolymerizable monomers include para-chlorostyrene; vinylnaphthalene; ethylene unsaturated monoolefins such as ethylene, propylene, butylene and isobutylene; halogenated vinyl such as vinyl chloride, vinyl bromide and vinyl fluoride; vinyl esters such as vinyl acetate, vinyl propionate, vinyl benzoate and vinyl butyrate; (meth)acrylate such as methyl acrylate, ethyl acrylate, n-butyl acrylate, isobutyl acrylate, dodecyl acrylate, n-octyl acrylate, 2-chloroethyl acrylate, phenyl acrylate, methyl α-chloracrylate, methyl methacrylate, ethyl methacrylate and butyl methacrylate; other acrylic acid derivatives such as acrylonitrile, methacrylonitrile and acrylamide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinylpyrrole, N-vinylcarbazole, N-vinylindole and N-vinylpyrrolidene. These can be used singly in one kind or copolymerized with a styrene monomer in a combination of two kinds or more.

The molecular weight of polystyrene resin or binding resin preferably has two mass-average molecular weight peaks (referred to as low-molecular weight peak and high-molecular weight peak). Specifically, it is preferable that the low-molecular weight peak is in a range of 3,000 to 20,000, the other high-molecular weight peak is in a range of 300,000 to 1,500,000 and Mw/Mn is 10 or more. When the mass-average molecular weight peaks are in such ranges, a toner can easily be fixed and resistance to offset can also be improved. The mass-average molecular weight of binding resin can be calculated in such a manner that elution time from a column is measured by using a molecular weight measuring apparatus (GPC), and collated with a calibration curve previously made by using standard polystyrene resin.

Polyester resin can be used if obtained by condensation polymerization and condensation copolymerization of an alcohol component and a carboxylic acid component. Examples of a component used for synthesizing polyester resin include the following. First, examples of divalent or trivalent or more alcohol component include diols such as ethylene glycol, diethylene glycol, triethylene glycol, 1,2-propylene glycol, 1,3-propylene glycol, 1,4-butanediol, neopentylglycol, 1,4-butenediol, 1,5-pentanediol, 1,6-hexanediol, 1,4-cyclohexandimethanol, dipropylene glycol, polyethylene glycol, polypropylene glycol and polytetramethylene glycol; bisphenols such as bisphenol A, hydrogenated bisphenol A, polyoxyethylenated bisphenol A and polyoxypropylenated bisphenol A; and trivalent or more alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethyl benzene.

Next, examples of divalent or trivalent or more carboxylic acid component include divalent or trivalent carboxylic acid, acid anhydride thereof or lower alkyl ester thereof: divalent carboxylic acids of alkyl or alkenyl succinic acid such as maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, or n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, isododecenylsuccinic acid; and trivalent or more carboxylic acids such as 1,2,4-benzenetricarboxylic acid (trimellitic acid), 1,2,5 -benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl- 2-methylenecarboxypropane, 1,2,4-cyclohexanetricarboxylic acid, tetra(methylecarboxyl)methane, 1,2,7,8-octanetetracarboxylic acid, pyromellitic acid and Enpol trimer acid.

The softening point of polyester resin is preferably 110 to 150° C., more preferably 120 to 140° C.

Binding resin is preferably thermoplastic resin from the viewpoint of favorable fixity, and yet may be thermosetting resin if cross-linking portion amount (gel amount) measured by using a Soxhlet extractor is a value of 10% by mass or less, more preferably a value in a range of 0.1 to 10% by mass. The partial introduction of a cross-linking structure in this manner allows storage stability, form retentivity or durability of a toner to be improved more without deteriorating fixity. Therefore, thermoplastic resin does not need to be used as binder resin of a toner up to 100% by mass, and it is also preferable to add a crosslinking agent or partially use thermosetting resin.

Accordingly, epoxy resin and cyanate resin can be used as thermosetting resin. More specific examples thereof include one kind or a combination of two kinds or more of bisphenol A epoxy resin, hydrogenated bisphenol A epoxy resin, novolac epoxy resin, polyalkylene ether epoxy resin, cycloaliphatic epoxy resin and cyanate resin.

The softening point is calculated with the use of a flow tester by a ½ method for measuring temperature at a point of time when ½ amount of a sample flows out on the conditions of sample amount: 1.8 g, die bore diameter: 1 mm, die length: 1 mm and extrusion pressure: 4 MPa With regard to a functional group in binding resin, in order to improve dispersibility of magnetic powder in such binding resin, resin having in a molecule at least one functional group selected from a hydroxyl group, a carboxyl group, an amino group and a glycidoxy (epoxy) group is preferably used. It can be confirmed by using FT-IR apparatus whether resin has these functional groups, which can further be subject to quantitative determination by using a titration method.

In binding resin, glass transition point (Tg) is preferably a value in a range of 55 to 70° C. A glass transition point of binding resin of less than 55° C. brings a tendency to fuse obtained toners together and decrease storage stability, while a glass transition point of binding resin of more than 70° C. brings a tendency to deteriorate fixity of a toner. The glass transition point of binder resin can be calculated from changeover point of specific heat by using a differential scanning calorimeter (DSC).

Tg described herein was calculated by the following measuring method. Specifically, DSC6200 manufactured by SII Nano Technology Inc. was used as an apparatus for measuring Tg, and approximately 10 mg of a sample was first put in a sample vessel made of aluminum, which was put on a holder unit and set in an electric furnace. Then, the vessel was heated from 30° C. to 170° C. at a rate of temperature rise of 10° C./min to thereafter cool the sample to 30° C., heat again to 170° C. at a rate of temperature rise of 10° C./min and perform DSC measurement.

Tg is obtained by calculating from a contact point of a tangential line of an endothermic curve in the neighborhood of Tg and the base line through the analysis system in DSC6200.

(Wax)

Wax is not particularly limited and examples thereof include vegetable waxes such as carnauba wax, sugarcane wax and sumac wax; animal waxes such as bees wax, insect wax, spermaceti wax and wool wax; and synthetic hydrocarbon waxes such as Fischer-Tropsch (occasionally referred to as “FT” hereinafter) wax having ester in a side chain, polyethylene wax and polypropylene wax. Among these, the use of FT wax having ester in a side chain and polyethylene wax is recommended in view of dispersibility.

With regard to wax, an endothermic main peak in an endothermic curve by a differential scanning calorimeter is preferably in a range of 70 to 100° C. A case where the endothermic main peak is less than 70° C. brings a possibility of causing toner blocking and hot offset, while a case where the endothermic main peak is more than 100° C. brings a possibility of not allowing low-temperature fixity.

The added amount of wax is preferably in a range of 0.1 to 20 parts by weight with respect to 100 parts by weight of binding resin. An added amount of wax of less than 0.1 part by weight allows the sufficient effect of wax with difficulty, while an added amount of wax of more than 20 parts by weight brings a possibility of decreasing resistance to blocking and causing desorption from a toner.

(Charge Control Agent)

A charge control agent is used for controlling triboelectrification properties of a toner, and a charge control agent for positive charge control and/or negative charge control is used in accordance with electrification polarity of a toner. Among these, examples of a charge control agent for positive charge control include organic compounds having a basic nitrogen atom such as basic dyestuffs, aminopyrine, pyrimidine compounds, polynuclear polyamino compounds and aminosilanes, and fillers surface-treated with each of the above-mentioned compounds.

Examples of a charge control agent for negative charge control include oil-soluble dyestuffs such as nigrosine base (CI5045), oil black (CI26150), BONTRON S and Spilon black; charge control resin such as a styrene-styrenesulfonic acid copolymer; compounds containing a carboxy group (such as alkyl salicylate metal chelate), metal complex salt dyestuffs, fatty acid metallic soap, resin acid soap, and naphthenic metal salt.

The added amount of a charge control agent is preferably 0.1 to 10 parts by weight, more preferably 0.5 to 8 parts by weight with respect to 100 parts by weight of fixing resin.

(Coloring Agent)

Examples of a coloring agent to be used include as black pigments, carbon black such as acetylene black, lamp black and aniline black; as yellow pigments, chrome yellow, zinc yellow, cadmium yellow, yellow iron oxide, mineral fast yellow, nickel titan yellow, Naples yellow, naphthol yellow S, Hansa yellow G, Hansa yellow 10G, benzidine yellow G, benzidine yellow GR, quinoline yellow lake, permanent yellow NCG and tartrazine lake; as orange pigments, chrome orange, molybdenum orange, permanent orange GTR, pyrazolone orange, vulcan orange, indathrene brilliant orange RK, benzidine orange G and indathrene brilliant orange GK; as red pigments, iron red, cadmium red, red lead, mercuric cadmium sulfide, permanent red 4R, lithol red, pyrazolone red, Watchung red calcium salt, lake red D, brilliant carmine 6B, eosine lake, rhodamine lake B, alizarin lake and brilliant carmine 3B; as violet pigments, manganese violet, fast violet B and methyl violet lake; as blue pigments, iron blue, cobalt blue, alkali blue lake, Victoria blue lake, phthalocyanine blue, metal-free phthalocyanine blue, phthalocyanine blue partially chlorinated matter, fast sky blue and indathrene blue BC; as green pigments, chrome green, chromium oxide, pigment green B, malachite green lake and fanal yellow green G; as white pigments, zinc flower, titanium oxide, antimony white and zinc sulfide; as white pigments, baryta powder, barium carbonate, clay, silica, white carbon, talc and alumina white.

The added amount of a coloring agent is preferably 1 to 20 parts by weight, more preferably 2 to 8 parts by weight with respect to 100 parts by weight of fixing resin in a case except for a magnetic toner. The added amount is 50 to 200 parts by weight with respect to 100 parts by weight of fixing resin in a case of a magnetic toner. A coloring agent in this case is magnetic powder.

(Offset Preventing Agent)

An offset preventing agent is blended for allowing the offset preventing effect to a toner. Examples of an offset preventing agent include aliphatic hydrocarbon, aliphatic metallic salts, higher fatty acids, fatty acid esters or partially saponified matter thereof, silicone oil and various waxes. Among these, aliphatic hydrocarbon having a weight-average molecular weight of approximately 1000 to 10000 is preferable. Specifically, the following are appropriate: one kind or a combination of two kinds or more of low-molecular-weight polypropylene, low-molecular-weight polyethylene, paraffin wax, low-molecular-weight olefin polymer composed of an olefin unit having the number of carbon atoms of 4 or more, and silicone oil.

The added amount of an offset preventing agent is preferably 0.1 to 10 parts by weight, more preferably 0.5 to 8 parts by weight with respect to 100 parts by weight of fixing resin. In addition, various additives such as a stabilizer may be blended at proper ratio.

(Magnetic Powder)

In a case where a toner of the present invention is used as a magnetic single-component toner, known magnetic powder can be dispersed into the toner and composed as a magnetic toner. Preferable examples of magnetic powder include metals or alloys exhibiting ferromagnetism such as ferrite, magnetite, iron, cobalt and nickel, compounds containing these ferromagnetic elements, or alloys containing no ferromagnetic elements but yet exhibiting ferromagnetism by performing proper heat treatment. The average particle diameter of magnetic powder is preferably a value in a range of 0.1 to 1 μm, more preferably a value in a range of 0.1 to 0.5 μm. The reason therefor is that magnetic powder having such an average particle diameter offers easy handling and can uniformly be dispersed into binder resin in the shape of fine powder.

A surface of magnetic powder is preferably treated with surface treatment agents such as a titanate coupling agent and a silane coupling agent. The reason therefor is that such surface treatment allows hygroscopicity and dispersibility of magnetic powder to be improved.

The added amount of magnetic powder is preferably 60 to 120 parts by weight, particularly preferably 80 to 100 parts by weight with respect to 100 parts by weight of binding resin.

(Image Forming Apparatus)

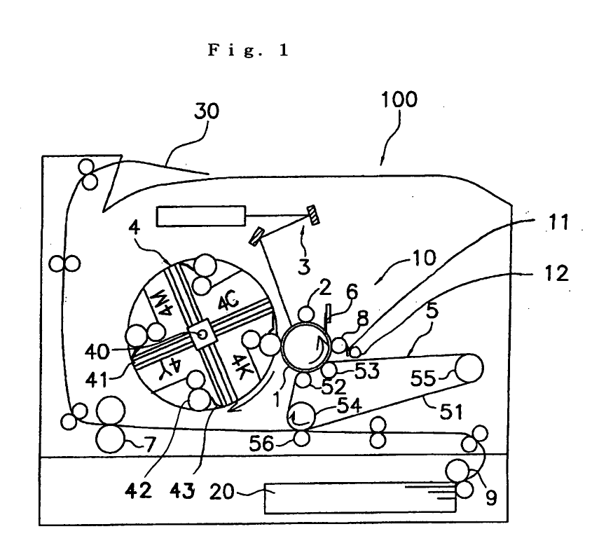

An image forming apparatus according to the present invention is an image forming apparatus in a rotary development system, and as shown in FIG. 1, an image forming portion 10 is provided in approximately the center of an image forming apparatus 100. The image forming portion 10 includes a photoreceptor drum 1, and in the periphery of the photoreceptor drum 1, a charging device 2, an exposure device 3, a developing device 4, a transfer device 5, a roller 8 and a cleaning blade 6 are sequentially disposed along the moving direction thereof A fixing device 7 is disposed on the downstream side of the photoreceptor drum 1 in the paper transport direction. A paper feed portion 20 is provided in the lower part of the image forming apparatus, and a paper feed roller 9 is disposed on the downstream side of the paper feed portion 20 in the paper feed direction.

The photoreceptor drum 1 is such that an electrostatic latent image is formed on a surface thereof. An amorphous silicon photoreceptor is used in the present example, and a constitution thereof is such that a carrier injection blocking layer composed of Si:H:B:O, a carrier excitation/transporting layer (a photoconductive layer) composed of Si:H and a surface protection layer composed of SiC:H are sequentially laminated on a conductive substrate. The charging device 2 is placed above the photoreceptor drum 1 and a device for evenly electrifying the photoreceptor drum 1. The exposure device 3 is a device for forming an electrostatic latent image on the photoreceptor drum 1 based on an original image read out from an image data input portion not shown in the drawing.

The developing device 4 is a device for forming a toner image on a surface of the photoreceptor drum 1, on which an electrostatic latent image is formed, by supplying a toner. Here, the developing device 4 is provided with a rotary rack 41, plural developing units 4Y, 4M, 4C and 4K, and a developing support 42 and a layer thickness control member 43 in each of the plural developing units. The rotary rack 41 is such as to sequentially move the plural developing units 4Y, 4M, 4C and 4K for development to a developing position facing the photoreceptor drum 1 while rotating on a rotation axis 40 by a rotary means not shown in the drawing. Among the plural developing units, the yellow developing unit 4Y, the magenta developing unit 4M, the cyan developing unit 4C and the black developing unit 4K are arranged and retained in order of 4Y, 4M, 4C and 4K in the circumferential direction of the rotary rack 41, and adjacent developing units are disposed at intervals of approximately 90 degrees in the circumferential direction. Each of the above-mentioned layer thickness control members 43 is selected for contact type or noncontact type in accordance with a toner used for each of the developing units.

The transfer device 5 is a device for transferring a toner image of the photoreceptor drum 1 to paper and is provided with a primary transfer belt 51, primary transfer rollers 52 and 53, a drive roller 55, a secondary transfer facing roller 54 and a secondary transfer roller 56. The primary transfer belt 51 is wound up on the primary transfer rollers 52 and 53, the drive roller 55 and the secondary transfer facing roller 54 in an endless state, and driven by the drive roller 55 to play the role of a transcript to which a toner image formed on the photoreceptor drum 1 is transferred and temporarily retained. The secondary transfer roller 56 is disposed at a position facing the secondary transfer facing roller 54 on the outer peripheral surface of the primary transfer belt 51 to play the role of secondarily transferring a toner image to a transfer material.

The cleaning blade 6 is a device for cleaning attachments such as a residual toner remaining on the photoreceptor drum 1, and a blade made of rubber having a hardness of 60 to 80 degrees (such as urethane rubber) is welded with pressure to the photoreceptor drum at a linear pressure of 10 to 40 N/m. The roller 8 abuts on a surface of the photoreceptor drum 1 to have the function of a buffer for recovering and discharging a toner. Here, the roller 8 has a constitution such that the circumference of a metal shaft is covered with a rubber layer having a hardness of 40 to 70 degrees (such as a foam rubber layer), and is energized to the photoreceptor drum 1 by springs (not shown) at both ends of a bearing at 500 to 2000 gf (250 to 1000 gf at one end of the springs).

With regard to the rotational speed of the roller 8, a surface speed in a contact portion is determined at 1 to 1.5 times faster than that of the drum. The fixing device 7 is a device for fixing a transferred toner image to paper. In FIG. 1, 11 is a scraper for peeling off a toner adhering to the roller and 12 is a recovery screw for recovering a toner adhering to the roller or a toner scraped off by the blade to fall on the roller. The above-mentioned recovery screw discharges a recovered residual toner into a waste toner box not shown in the drawing.

Next, a method of forming a color image is described. During image formation, after the photoreceptor drum 1 is electrified by the charging means 2, the rotary rack 41 rotates on the rotation axis 40 provided at the central portion thereof Then, in the rotary rack 41, the developing unit 4K corresponding to black as a first color stops at a developing position as a position facing the photoreceptor drum 1. In this state, exposure corresponding to black is performed by the exposure means 3 and an electrostatic latent image corresponding to black is formed on a surface of the photoreceptor drum 1. This electrostatic latent image is changed into a toner image in the developing unit 4K and this toner image formed on a surface of the photoreceptor drum 1 is transferred to the primary transfer belt 51 by transfer bias impressed on the primary transfer rollers 52 and 53. When the formation of the black toner image on the primary transfer belt 51 is completed in this manner, next the rotary rack 41 rotates on the rotation axis 40 provided at the central portion thereof, and for example, the developing unit 4M corresponding to cyan is located at a developing position. Such an action is performed in the same way with regard to other colors, namely, cyan, magenta and yellow, so that a toner image in full color is formed on the primary transfer belt 51.

As described above, in a process such that a toner image is primarily transferred to the primary transfer belt 51, the secondary transfer roller 56 is separated from the primary transfer belt 51. On the other hand, when a toner image in full color is formed on the primary transfer belt 51, the secondary transfer roller 56 abuts on the primary transfer belt 51. On the occasion, a toner image in full color formed on the primary transfer belt 51 is transferred by secondary transfer bias impressed on the secondary transfer roller 56 to a transfer material conveyed from the paper feed portion 20 to a transfer position by the paper feed roller 9 and the like with proper timing. In addition, a toner image in full color transferred to a transfer material is fixed to the transfer material with heating and pressurization by the fixing means 7, which transfer material is discharged into a paper discharging portion 30.

A residual toner remaining in the photoreceptor drum 1 is cleaned by the cleaning blade 6 and discarded to a waste toner container not shown in the drawing. A toner remaining in the primary transfer belt 51 is cleaned in such a manner that a cleaning device not shown in the drawing of the primary transfer belt 51 abuts on the primary transfer belt 51 after secondary transfer, and discarded to a waste toner container not shown in the drawing. The cleaning device not shown in the drawing of the primary transfer belt 51 cleans one round of the primary transfer belt 51 and thereafter is separated from the primary transfer belt 51.

During monochromatic image formation, the rotary rack 41 does not rotate and only the developing unit 4K faces the photoreceptor drum 1 to perform development. Other actions of image formation are the same as color image formation.

An image forming apparatus of one embodiment according to the present invention is described with regard to the above-mentioned image forming apparatus in a rotary development system, and yet not limited thereto but can be used for an image forming apparatus in a tandem system, for example, in which plural photoreceptors corresponding to colors of a toner are used and synchronized with the feed of a transfer member to form a color image and perform color overlapping on the transfer member.

### EXAMPLES

The following examples illustrate the manner in which the present invention can be practiced. It is understood, however, that the examples are for the purpose of illustration and the invention is not to be regarded as limited to any of the specific materials or condition therein.

### Example 1

First, binding resin used for the present invention was produced in the following manner. 300 parts by mass of xylene was charged into a reaction vessel with a thermometer, a stirrer and a nitrogen inlet tube, and mixed solution of a mixed monomer of 845 parts by mass of styrene and 155 parts by mass of n-butyl acrylate, 8.5 parts by mass of di-tert-butyl peroxide (a polymerization initiator) and 125 parts by mass of xylene was dropped thereinto under nitrogen gas stream at a temperature of 170° C. over 3 hours. After the dropping, the reaction was performed at a temperature of 170° C. for 1 hour to complete the polymerization. Thereafter, desolvation was performed to obtain binding resin.

(Black Toner)

With regard to a black toner, 45 parts by mass of magnetic powder (a holding power of 5.0 kA/m, a saturation magnetization of 82 Am²/kg and a residual magnetization of 11 Am²/kg under an impression of 796 kA/m, and a number-average particle diameter of 0.25 μm), 3 parts by mass of wax (SASOL WAX H1, manufactured by SASOL) as a release agent and 3 parts by mass of quaternary ammonium salt (BONTRON P-51, manufactured by Orient Chemical Industries Ltd.) as a positive charge control agent were mixed into 49 parts by mass of binding resin obtained in the above by a Henschel mixer, and thereafter melt-kneaded by a twin-screw extruder and thereafter cooled, and subject to coarse grinding by a hammer mill. The mixture was further subject to fine grinding by a mechanical grinder and classified by an air sifter to obtain magnetic toner particles having a volume-average particle diameter of 8.0 μm. The average circularity of the obtained black toner particles was 0.950. The adjustment of circularity was performed by the number of passes of a mechanical grinder.

0.7 part by weight of silica having a primary particle diameter of 20 nm subject to aminosilane treatment and further silicone oil treatment, and 0.8 part by weight of titanium oxide having a primary particle diameter of 50 nm subject to titanate coupling treatment were added to 100 parts by weight of these toner particles and mixed at 3000 rpm for 10 minutes by a Henschel mixer to obtain a black toner.

(Color Toner)

On the other hand, with regard to a color toner, mixed solution of 80 parts by mass of styrene and 20 parts by mass of 2-ethylhexyl methacrylate as binding resin, 5 parts by mass of Toner Magenta E02 (manufactured by Clariant (Japan) K.K.) as a coloring agent, 3 parts by mass of low-molecular-weight polypropylene as an offset preventing agent, 2 parts by mass of a charge control agent (BONTRON S-34) and 1 part by mass of divinylbenzene as a crosslinking agent was sufficiently dispersed by a ball mill. Subsequently, 2 parts by mass of 2,2-azobis (2,4-dimethylvaleronitrile) as a polymerization initiator was added thereto and further added to 400 parts by mass of ion-exchange water, and further 5 parts by mass of tribasic calcium phosphate and 0.1 part by mass of sodium dodecylbenzenesulfonate as a suspension stabilizer were added thereto, stirred at the number of revolutions of 5000 rpm for 45 minutes by using a TK homomixer (manufactured by PRIMIX Corporation) and subject to polymerization reaction under nitrogen atmosphere at 70° C. and 100 rpm for 10 hours. Thereafter, acid washing was performed to obtain toner mother particle dispersion having a volume-average particle diameter of 7.5 μm from which tribasic calcium phosphate was removed. This dispersion was filtered, washed and dried to obtain color toner particles in magenta. The average circularity of the obtained toner particles was 0.975.

1.2 parts by weight of silica having a primary particle diameter of 20 nm subject to aminosilane treatment and further silicone oil treatment, and 1.2 parts by weight of titanium oxide having a primary particle diameter of 50 nm subject to titanate coupling treatment were added to 100 parts by weight of these toner particles and mixed at 3000 rpm for 10 minutes by a Henschel mixer to prepare a non-magnetic color toner in magenta.

Toner Cyan BG (manufactured by Clariant(Japan)K.K.) and Toner Yellow HG (manufactured by Clariant(Japan)K.K.) were used as a coloring agent instead of Toner Magenta E02 (manufactured by Clariant(Japan)K.K.) to prepare a non-magnetic color toner in each of cyan and yellow in the same way as the above-mentioned color toner in magenta.

With regard to the above-mentioned primary particle diameter, a photograph of a toner particle surface magnified by 30,000 times was taken by SEM (scanning electron microscope: JSM-880, manufactured by JEOL Ltd.) to measure a particle diameter in any of 100 particles by an image analysis device (Macview, manufactured by Mountech Co., Ltd.) and calculate a number-average primary particle diameter thereof through arithmetic mean.

### Example 2

In the above-mentioned preparation of a color toner, a black toner and a color toner were prepared in the same manner as the above-mentioned Example 1 except for modifying an added amount of the above-mentioned silica of 1.2 parts by weight into 1.05 parts by weight.

### Example 3

In the above-mentioned preparation of a black toner, a black toner and a color toner were prepared in the same manner as the above-mentioned Example 1 except for modifying an average circularity of the black toner particles of 0.950 into 0.958.

### Example 4

A color toner was prepared in the same manner as a black toner of Example 1 except for modifying binding resin into 100 parts by mass, and magnetic powder into 5 parts by mass of Toner Magenta E02 (manufactured by Clariant (Japan) K.K.).

Toner Cyan BG (manufactured by Clariant (Japan) K.K.) and Toner Yellow HG (manufactured by Clariant (Japan) K.K.) were used as a coloring agent instead of Toner Magenta E02 (manufactured by Clariant (Japan) K.K.) to prepare a non-magnetic color toner in each of cyan and yellow in the same way as the above-mentioned color toner in magenta.

The average circularity of the obtained toner was 0.962.

### Comparative Example 1

In the above-mentioned preparation of a black toner, a black toner and a color toner were prepared in the same manner as the above-mentioned Example 1 except for modifying an average circularity of the black toner particles of 0.950 into 0.962.

### Comparative Example 2

In the above-mentioned preparation of a color toner, a black toner and a color toner were prepared in the same manner as the above-mentioned Example 1 except for modifying an added amount of the above-mentioned titanium oxide of 1.2 parts by weight into 1.1 parts by weight.

### Comparative Example 3

A black toner and a color toner were prepared in the same manner as the above-mentioned Example 1 except for modifying an added amount of the above-mentioned silica of 0.7 part by weight into 0.6 part by weight and an added amount of the above-mentioned titanium oxide of 0.8 part by weight into 0.7 part by weight in the above-mentioned preparation of a black toner, and modifying an added amount of the above-mentioned silica of 1.2 parts by weight into 0.9 part by weight and an added amount of the above-mentioned titanium oxide of 1.2 parts by weight into 1.0 part by weight in the above-mentioned preparation of a color toner.

### Comparative Example 4

In the above-mentioned preparation of a color toner, a black toner and a color toner were prepared in the same manner as the above-mentioned Example 1 except for modifying an average circularity of the color toner particles of 0.975 into 0.950 by a preparation of a color toner using the grinding method.

### Comparative Example 5

In the above-mentioned preparation of a color toner, a black toner and a color toner were prepared in the same manner as the above-mentioned Example 1 except for modifying an added amount of the above-mentioned silica of 1.2 parts by weight into 0.9 parts by weight.

These are shown in Table 1.

TABLE 1

| | Black toner | | | Color toner | | |
|---|---|---|---|---|---|---|
| | | Added amount | | | Added amount | |
| | | of inorganic | | | of inorganic | |
| | | fine particles | | | fine particles | |
| | | (% by mass)¹⁾ | | | (% by mass)¹⁾ | |
| | Circu- | | Titanium | | | Titanium |
| | larity | Silica | oxide | Circularity | Silica | oxide |
| Example 1 | 0.950 | 0.70 | 0.80 | 0.975 | 1.20 | 1.20 |
| Example 2 | 0.950 | 0.70 | 0.80 | 0.975 | 1.05 | 1.20 |
| Example 3 | 0.958 | 0.70 | 0.80 | 0.975 | 1.20 | 1.20 |
| Example 4 | 0.950 | 0.70 | 0.80 | 0.962 | 1.20 | 1.20 |
| Comparative | 0.962 | 0.70 | 0.80 | 0.975 | 1.20 | 1.20 |
| Example 1 | | | | | | |
| Comparative | 0.950 | 0.70 | 0.80 | 0.975 | 1.20 | 1.10 |
| Example 2 | | | | | | |
| Comparative | 0.950 | 0.60 | 0.70 | 0.975 | 0.90 | 1.00 |
| Example 3 | | | | | | |
| Comparative | 0.950 | 0.70 | 0.80 | 0.950 | 1.20 | 1.20 |
| Example 4 | | | | | | |
| Comparative | 0.950 | 0.70 | 0.80 | 0.975 | 0.90 | 1.20 |
| Example 5 | | | | | | |

¹⁾In the Table, added amount is in % by mass with respect to toner total amount.

(Measurement of Circularity)

In the present invention, the average value of circularity of toner particles was measured by the following method. That is, a predetermined amount of sampled toner particles were analyzed by using a flow-type particle image analysis device (FPIA2100) to measure circumference L of a projected image such that individual toner particles were projected on a plane. A circle having the same area as the projected image was assumed to measure circumference Lo thereof Then, a process of calculating circularity represented by the ratio of both Lo/L denoted in the above-mentioned expression (1) was performed for the total amount of sampled toner particles to measure a cumulative curve of circularity and regard a cumulative median (50% value) thereof as the average value.

<Evaluation Test≧

### Examples 1 to 4 and Comparative Examples 1 to 5

Any one of developers of Examples 1 to 4 and Comparative Examples 1 to 5 obtained in the above was mounted on a remodeled machine of a color printer (trade name “FS-8000C”) manufactured by KYOCERA MITA CORPORATION to perform evaluations of image density, fogging, cleaning properties, photoreceptor drum fouling and image roughness. These results were shown in Table 2.

Evaluation methods and evaluation criteria are as follows.

(1) Image Density (ID) and Fogging (FD)

An image evaluation pattern was initially printed in normal temperature and humidity environment (20° C., 65%-RH) and regarded as the initial image to thereafter perform serial printing (a printing rate of approximately 5%) up to ten thousand sheets and subsequently a hundred thousand sheets and print the image evaluation pattern again, which was regarded as the image after endurance.

With regard to image density, each solid image was measured by using a Macbeth reflection densitometer (RD914). The evaluation criterion is as follows. An ID of 1.30 or more was regarded as pass.
◯:1.30 or more
Δ:1.20 or more and less than 1.30
×:less than 1.20

Fogging was measured by using a reflection densitometer (TC-6D, manufactured by TOKYO DENSHOKU). The evaluation criterion is as follows. An FD of 0.010 or less was regarded as pass.
◯:0.010 or less
Δ:0.011 or more and less than 0.020
×:0.020 or more
   (2) Cleaning Properties

Cleaning properties of a photoreceptor during formation of the initial image and after serial printing (a printing rate of approximately 5%) up to ten thousand sheets and subsequently a hundred thousand sheets were measured through visual observation. The evaluation criterion is as follows.
◯:no cleaning defect caused
Δ:cleaning defect caused but yet image content recognized
×:cleaning defect caused and image content not recognized
(3) Photoreceptor Drum Fouling

The occurrence of filming on a photoreceptor surface was measured through visual observation as photoreceptor drum fouling during formation of the initial image and after serial printing (a printing rate of approximately 5%) up to ten thousand sheets and subsequently a hundred thousand sheets. The evaluation criterion is as follows.
◯:no filming caused
Δ:filming caused but yet image content recognized
×:filming caused and image content not recognized
   (4) Image Roughness

A print image was initially printed and roughness of the image surface was measured through visual observation. The evaluation criterion is as follows.
◯:no roughness recognized
Δ:roughness slightly recognized

×:roughness considerably recognized

TABLE 2

| | Image density | | | Fogging | | |
|---|---|---|---|---|---|---|
| | | After ten thousand | After a hundred | | After ten thousand | After a hundred |
| | Initial | sheets | thousand sheets | Initial | sheets | thousand sheets |
| Example 1 | ◯ | ◯ | ◯ | ◯ | ◯ | ◯ |
| Example 2 | ◯ | ◯ | ◯ | ◯ | ◯ | ◯ |
| Example 3 | ◯ | ◯ | ◯ | ◯ | ◯ | ◯ |
| Example 4 | ◯ | ◯ | ◯ | ◯ | ◯ | ◯ |
| Comparative | ◯ | ◯ | — | ◯ | ◯ | — |
| Example 1 | | | | | | |
| Comparative | ◯ | ◯ | ◯ | ◯ | ◯ | ◯ |
| Example 2 | | | | | | |
| Comparative | ◯ | ◯ | — | ◯ | ◯ | — |
| Example 3 | | | | | | |
| Comparative | ◯ | ◯ | ◯ | ◯ | ◯ | ◯ |
| Example 4 | | | | | | |
| Comparative | ◯ | ◯ | ◯ | ◯ | ◯ | ◯ |
| Example 5 | | | | | | |

| | Cleaning defect | | | Photoreceptor filming | | | |
|---|---|---|---|---|---|---|---|
| | | After ten | After a hundred | | After ten | After a hundred | |
| | Initial | thousand sheets | thousand sheets | Initial | thousand sheets | thousand sheets | Roughness |
| Example 1 | ◯ | ◯ | ◯ | ◯ | ◯ | ◯ | ◯ |
| Example 2 | ◯ | ◯ | ◯ | ◯ | ◯ | ◯ | ◯ |
| Example 3 | ◯ | ◯ | ◯ | ◯ | ◯ | ◯ | ◯ |
| Example 4 | ◯ | ◯ | ◯ | ◯ | ◯ | ◯ | ◯ |
| Comparative | ◯ | X | — | ◯ | ◯ | — | ◯ |
| Example 1 | | | | | | | |
| Comparative | ◯ | ◯ | Δ | ◯ | Δ | X | ◯ |
| Example 2 | | | | | | | |
| Comparative | ◯ | X | — | ◯ | Δ | — | ◯ |
| Example 3 | | | | | | | |
| Comparative | ◯ | ◯ | ◯ | ◯ | ◯ | ◯ | X |
| Example 4 | | | | | | | |
| Comparative | ◯ | ◯ | X | ◯ | ◯ | ◯ | ◯ |
| Example 5 | | | | | | | |

Notes)
In the Table, “—” denotes discontinuance of evaluations due to the reason of being evaluated as X at a point of time when the printing exceeds ten thousand sheets.

As shown in the Table, in Comparative Example 1, the circularity of a black toner was as high as out of the range, so that the black toner passed through a cleaning blade to cause cleaning defect. In Comparative Example 2, the titanium amount of a color toner was less than 1.5 times the titanium amount of a black toner, so that grinding force ran short to cause photoreceptor filming. In Comparative Example 3, the total amount of inorganic fine powder of a black toner and a color toner ran short to cause grinding force shortage of the black toner and the color toner and passing of the color toner through a cleaning blade, leading to the occurrence of cleaning defect and photoreceptor filming. In Comparative Example 4, the circularity of a color toner was as low as out of the range, so that a print image lost smoothness of an image surface by decreasing of transfer efficiency and so forth. In Comparative Example 5, the total amount of inorganic fine powder of a color toner ran short to cause passing of the color toner through a cleaning blade, leading to the occurrence of cleaning defect after a hundred thousand sheets.

On the contrary, in Examples 1 to 4 within the scope of the present invention, image density and fogging were favorable, and cleaning properties and photoreceptor drum fouling were not caused.

It was confirmed by the above that the present invention allowed a favorable grinding state of a photoreceptor to be retained and allowed a favorable image to be provided in long-period use with no cleaning defect.

It is further understood by those skilled in the art that the foregoing description is a preferred embodiment of the disclosed image forming apparatus and that various changes and modifications may be made in the invention without departing from the spirit and scope thereof. In Claims and description, “% by mass” may be replaced with “% by weight”.

1. A developer used for an image forming method containing the step of forming a color image by using a single photoreceptor and removing a toner remaining on the photoreceptor after the transfer step with a cleaning blade, wherein
the developer is composed of a black toner having a circularity of 0.96 or less and a color toner having a circularity of 0.96 or more;
at least inorganic particles containing Si compound particles and Ti compound particles are externally added to both of the black toner and the color toner; and
an amount of the inorganic particles externally added to the black toner and the color toner satisfies the expressions (1) and (2),
{Si(C)+Ti(C)}≧1.5×{Si(Bk)+Ti(Bk)} (1)
Ti(C)≧1.5×Ti(Bk) (2)
in which,
Si(C): an amount of inorganic particles containing Si externally added to a color toner (% by mass),
Ti(C): an amount of inorganic particles containing Ti externally added to a color toner (% by mass),
Si(Bk): an amount of inorganic particles containing Si externally added to a black toner (% by mass),
Ti(Bk): an amount of inorganic particles containing Ti externally added to a black toner (% by mass), in which % by mass is a value with respect to the toner total amount.

2. A developer according to claim 1, wherein the black toner is a magnetic toner produced by a grinding method and the color toner is a non-magnetic toner produced by a polymerization method.

3. A developer according to claim 1, wherein said amount of the inorganic particles externally added to the black toner satisfies the expression (3),
Si(Bk)+Ti(Bk)≧1.5 (3)
in which, Si(Bk) and Ti(Bk) are as defined as follows:
Si(Bk): an amount of inorganic particles containing Si externally added to a black toner (% by mass),
Ti(Bk): an amount of inorganic particles containing Ti externally added to a black toner (% by mass).

4. An image forming method for forming a color image, comprising:
the charging step of charging a surface of a photoreceptor; the exposing step of exposing said surface of the charged photoreceptor to form a latent image;
the developing step of rotationally moving developing units having developers (toners) in plural colors selectively to a developing position facing said photoreceptor to form a toner image in said latent image on the photoreceptor;
the primary transfer step of sequentially transferring said toner image formed on the photoreceptor to a primary transfer material to form a toner image in full color;
the secondary transfer step of transferring said toner image in full color to a secondary transfer material; and
the cleaning step of removing a toner remaining on said photoreceptor after the secondary transfer step with a cleaning blade; wherein said developer is composed of a black toner having a circularity of 0.96 or less and a color toner having a circularity of 0.96 or more;
at least inorganic particles containing Si compound particles and Ti compound particles are externally added to both of the black toner and the color toner; and
an amount of the inorganic particles externally added to the black toner and the color toner satisfies the expressions (1) and (2),
{Si(C)+Ti(C)}≧1.5×{Si(Bk)+Ti(Bk)} (1)
Ti(C)≧1.5×Ti(Bk) (2)
in which,
Si(C): an amount of inorganic particles containing Si externally added to a color toner (% by mass),
Ti(C): an amount of inorganic particles containing Ti externally added to a color toner (% by mass),
Si(Bk): an amount of inorganic particles containing Si externally added to a black toner (% by mass),
Ti(Bk): an amount of inorganic particles containing Ti externally added to a black toner (% by mass),
in which % by mass is a value with respect to the toner total amount.

5. An image forming method according to claim 4, wherein the black toner is a magnetic toner produced by a grinding method and the color toner is a non-magnetic toner produced by a polymerization method.

6. An image forming method according to any claim 4, wherein said amount of the inorganic particles externally added to the black toner satisfies the above expression (3).

7. An image forming apparatus for forming a color image, comprising:
charging device of charging a surface of a photoreceptor; the exposing device of exposing said surface of the charged photoreceptor to form a latent image;
developing device of rotationally moving developing units having developers (toners) in plural colors selectively to a developing position facing said photoreceptor to form a toner image in said latent image on the photoreceptor;
primary transfer device of sequentially transferring said toner image formed on the photoreceptor to a primary transfer material to form a toner image in full color;
secondary transfer device of transferring said toner image in full color to a secondary transfer material; and
cleaning device of removing a toner remaining on said photoreceptor after the secondary transfer with a cleaning blade;
wherein the developer according to claim 1 is used.

8. An image forming method according to claim 5, wherein said amount of the inorganic particles externally added to the black toner satisfies the above expression (3).
